(19) United States
(12) Patent Application Publication
(10) Pub. No.: US 2024/0256733 A1
(43) Pub. Date: Aug. 1, 2024

(54) THREE-DIMENSIONAL PRINTING SOLUTION FOR PROBLEM CORRECTION DURING 3D OBJECT ASSEMBLY

(71) Applicant: INTERNATIONAL BUSINESS MACHINES CORPORATION, ARMONK, NY (US)

(72) Inventors: Fang Lu, Billerica, MA (US); Martin G. Keen, Cary, NC (US); Jeremy R. Fox, Georgetown, TX (US); Sarbajit K. Rakshit, Kolkata (IN)

(21) Appl. No.: 18/159,907

(22) Filed: Jan. 26, 2023

(51) Int. Cl. G06F 30/20; B29C 64/393; B33Y 50/02

(52) U.S. Cl. CPC G06F 30/20; B29C 64/393; B33Y 50/02; G06F 2113/10; G06F 2119/18

(57) ABSTRACT

An embodiment for correcting a problem during an assembly of a 3D object utilizing a 3D printing solution is provided. The embodiment may include receiving a 3D printing blueprint. The embodiment may also include executing a virtual simulation of the assembly of the plurality of 3D blocks. The embodiment may further include in response to determining at least one problem condition arises during the execution of the virtual simulation, identifying the at least one problem condition among the plurality of 3D blocks. The embodiment may also include executing a digital twin simulation of a digital twin model of a plurality of physically assembled 3D blocks. The embodiment may further include generating a correction plan including one or more corrective actions to be performed on the plurality of physically assembled 3D blocks. The embodiment may also include executing the one or more corrective actions.

### BACKGROUND

The present invention relates generally to the field of computing, and more particularly to a system for correcting a problem during an assembly of a 3D object utilizing a 3D printing solution.

3D printing or additive manufacturing is the process of making three-dimensional solid objects from a digital file. The creation of a 3D printed object may be achieved using additive processes. In an additive manufacturing process, an object may be created by laying down successive layers of material until the object is formed. Each layer of material may be a thinly sliced cross-section of the object. In this manner, 3D printing enables the production of complex shapes using less material than that of traditional manufacturing methods. Any 3D printer may be equipped with a 3D printing nozzle, where each layer of material may be emitted from an opening in the 3D printing nozzle.

### SUMMARY

According to one embodiment, a method, computer system, and computer program product for correcting a problem during an assembly of a 3D object utilizing a 3D printing solution is provided. The embodiment may include receiving a 3D printing blueprint containing a description of a plurality of 3D blocks capable of being assembled to create an object. The embodiment may also include executing a virtual simulation of the assembly of the plurality of 3D blocks based on the 3D printing blueprint. The embodiment may further include in response to determining at least one problem condition arises during the execution of the virtual simulation, identifying the at least one problem condition among the plurality of 3D blocks based on the execution of the virtual simulation. The embodiment may also include executing a digital twin simulation of a digital twin model of a plurality of physically assembled 3D blocks in accordance with one or more factors. The embodiment may further include generating a correction plan including one or more corrective actions to be performed on the plurality of physically assembled 3D blocks based on the at least one problem condition and the executed digital twin simulation. The embodiment may also include executing the one or more corrective actions on the plurality of physically assembled 3D blocks based on the generated correction plan.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary computing environment according to at least one embodiment.

FIG. 2 illustrates an operational flowchart for correcting a problem during an assembly of a 3D object utilizing a 3D printing solution in a 3D printing solution process according to at least one embodiment.

FIG. 3 is an exemplary diagram depicting a virtual assembly of a plurality of 3D blocks requiring problem correction according to at least one embodiment.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may however, be embodied in many different forms and should not be construed as limited to the exemplary embodiments set forth herein. In the description, details of well-known features and techniques may be omitted to avoid unnecessarily obscuring the presented embodiments.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

Embodiments of the present invention relate to the field of computing, and more particularly to a system for correcting a problem during an assembly of a 3D object utilizing a 3D printing solution. The following described exemplary embodiments provide a system, method, and program product to, among other things, identify at least one problem condition among a plurality of 3D blocks based on a 3D printing blueprint and, accordingly, execute one or more corrective actions on a created object based on a generated printing plan. Therefore, the present embodiment has the capacity to improve 3D printing technology by dynamically identifying where correction is required in 3D printing.

As previously described, 3D printing or additive manufacturing is the process of making three-dimensional solid objects from a digital file. The creation of a 3D printed object may be achieved using additive processes. In an additive manufacturing process, an object may be created by laying down successive layers of material until the object is formed. Each layer of material may be a thinly sliced cross-section of the object. In this manner, 3D printing enables the production of complex shapes using less material than that of traditional manufacturing methods. Any 3D printer may be equipped with a 3D printing nozzle, where each layer of material may be emitted from an opening in the 3D printing nozzle. When large blocks are assembled to form an object, the large blocks may not be properly aligned or joined, causing instability in the assembled object. This problem is typically addressed by 3D printing a material to repair a broken object. However, 3D printing the material to repair the broken object is reactive and fails to proactively identify problems among different 3D blocks from a virtual representation.

It may therefore be imperative to have a system in place to dynamically create a proper course of action to rectify problems in an assembled object. Thus, embodiments of the present invention may provide advantages including, but not limited to, dynamically creating a proper course of action to rectify problems in an assembled object, proactively identifying problems among different 3D blocks from a virtual representation, and utilizing 3D printing to optimize stability in the assembled object. The present invention does not require that all advantages need to be incorporated into every embodiment of the invention.

According to at least one embodiment, when objects are to be assembled, a 3D printing blueprint containing a description of a plurality of 3D blocks capable of being assembled to create an object may be received in order to execute a virtual simulation of the assembly of the plurality of 3D blocks based on the 3D printing blueprint. Upon executing the virtual simulation, it may be determined whether at least one problem condition arises during the execution of the virtual simulation. In response to determining the at least one problem condition arises, the at least one problem condition among the plurality of 3D blocks may be identified based on the execution of the virtual simulation. Then, a digital twin simulation of a digital twin model of a plurality of physically assembled 3D blocks may be executed in accordance with one or more factors so that a correction plan including one or more corrective actions to be performed on the plurality of physically assembled 3D blocks may be generated based on the at least one problem condition and the executed digital twin simulation. Upon generating the correction plan, the one or more corrective actions may be executed on the plurality of physically assembled 3D blocks based on the generated correction plan. According to at least one embodiment, the generated correction plan may include an instruction to execute the one or more corrective actions on the plurality of physically assembled 3D blocks before the created object is complete in response to identifying at least one first condition. According to at least one other embodiment, the generated correction plan may include an instruction to execute the one or more corrective actions on the plurality of physically assembled 3D blocks after the created object is complete in response to identifying at least one second condition.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The following described exemplary embodiments provide a system, method, and program product to identify at least one problem condition among a plurality of 3D blocks based on a 3D printing blueprint and, accordingly, execute one or more corrective actions on a created object based on a generated printing plan.

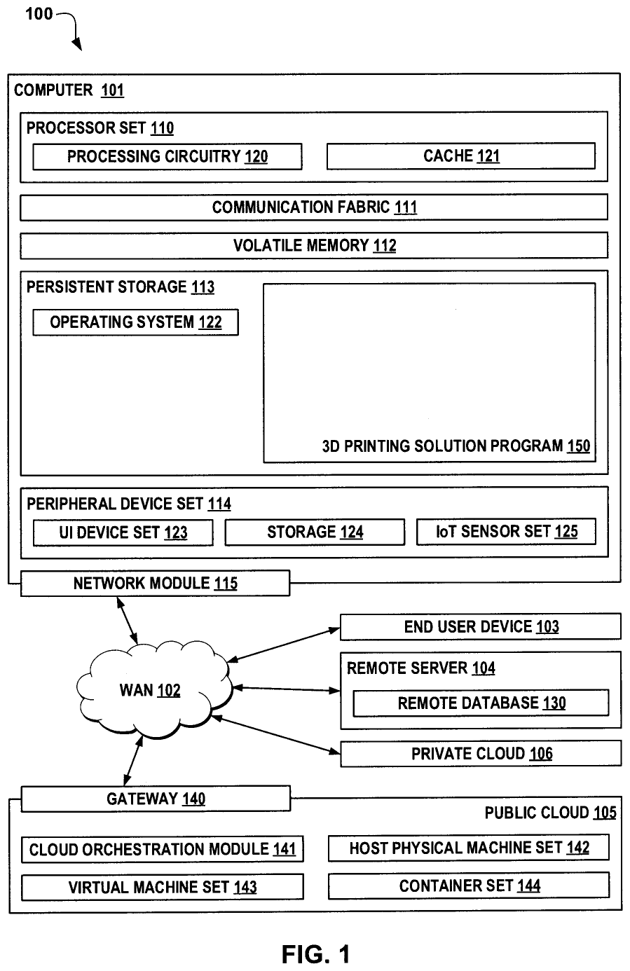

Referring to FIG. 1, an exemplary computing environment 100 is depicted, according to at least one embodiment. Computing environment 100 contains an example of an environment for the execution of at least some of the computer code involved in performing the inventive methods, such as a 3D printing solution program 150. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory 112 is characterized by random access, but this is not required unless affirmatively indicated. In computer 101, the volatile memory 112 is located in a single package and is internal to computer 101, but, alternatively or additionally, the volatile memory 112 may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage 113 allows writing of data, deletion of data and re-writing of data. Some familiar forms of persistent storage 113 include magnetic disks and solid state storage devices. Operating system 122 may take several forms, such as various known proprietary operating systems or open source Portable Operating System Interface type operating systems that employ a kernel. The code included in block 150 typically includes at least some of the computer code involved in performing the inventive methods.

Peripheral device set 114 includes the set of peripheral devices of computer 101. Data communication connections between the peripheral devices 114 and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database), this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector. Peripheral device set 114 may also include a machine, a 3D printer, a robotic device, and/or any other device for performing labor related tasks.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN 102 and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments the private cloud 106 may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

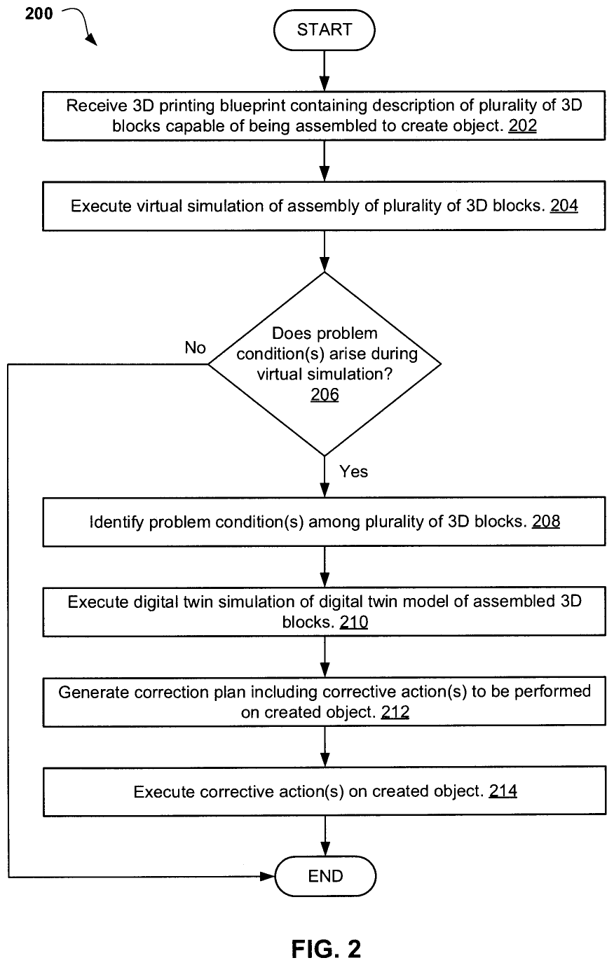

According to the present embodiment, the 3D printing solution program 150 may be a program capable of receiving a 3D printing blueprint containing a description of a plurality of 3D blocks capable of being assembled to create an object, identifying at least one problem condition among the plurality of 3D blocks based on the 3D printing blueprint, executing one or more corrective actions on the created object based on a generated printing plan, dynamically creating a proper course of action to rectify problems in an assembled object, proactively identifying problems among different 3D blocks from a virtual representation, and utilizing 3D printing to optimize stability in the assembled object. Furthermore, notwithstanding depiction in computer 101, the self-developing resource program 150 may be stored in and/or executed by, individually or in any combination, end user device 103, remote server 104, public cloud 105, and private cloud 106. The 3D printing solution method is explained in further detail below with respect to FIG. 2. It may be appreciated that the examples described below are not intended to be limiting, and that in embodiments of the present invention the parameters used in the examples may be different.

Referring now to FIG. 2, an operational flowchart for correcting a problem during an assembly of a 3D object utilizing a 3D printing solution in a 3D printing solution process 200 is depicted according to at least one embodiment. At 202, the 3D printing solution program 150 receives the 3D printing blueprint containing the description of the plurality of 3D blocks capable of being assembled to create the object. As used herein, the “plurality of 3D blocks” means virtual 3D blocks, whereas the “plurality of physically assembled 3D blocks” means physical 3D blocks in the real-world environment. The description of the plurality of 3D blocks may include the specifications and the shape of each of the plurality of 3D blocks. For example, each of the plurality of 3D blocks may be 2 feet in length, 2 feet in width, and 1 foot in height with a square shape.

The 3D printing blueprint may also uniquely identify the object to be created and the particular design of the object. Examples of the object may include, but are not limited to, a building (e.g., a house, office, or store), a dam, a bridge, and/or an overpass. Based on the identity and the design of the object, the 3D printing solution program 150 may identify how to assemble the object, described in further detail below with respect to step 204.

Then, at 204, the 3D printing solution program 150 executes the virtual simulation of the assembly of the plurality of 3D blocks. The virtual simulation is executed based on the 3D printing blueprint. The virtual simulation may include assembling each 3D block of the plurality of 3D blocks in a step-by-step process until a complete virtual representation of the object is created. One or more mathematical models may be utilized in the execution of the virtual simulation.

According to at least one embodiment, the mathematical model may be a finite element analysis (FEA) model. The FEA model may describe the behavior of structures that are subjected to dynamic loads. This model may be useful in predicting the strength of the assembled object.

According to at least one other embodiment, the mathematical model may be a discrete element method (DEM) model. The DEM model may describe the behavior of particles that make up a discontinuous material. For example, the discontinuous material may be a granular material. This model may be useful in predicting the motion and contact forces among various 3D blocks during the assembly of the object.

According to at least one further embodiment, the mathematical model may be a molecular dynamics (MD) model. The MD model may describe the motion of particles that make up a continuous material. For example, the continuous material may be a liquid material. This model may be useful in predicting the flow of liquid materials during the assembly of the object.

Next, at 206, the 3D printing solution program 150 determines whether the at least one problem condition arises during the execution of the virtual simulation. Examples of the problem condition may include, but are not limited to, a gap among the plurality of 3D blocks, an improper alignment among the plurality of 3D blocks, and/or an improper surface dimension of at least one 3D block in the plurality of 3D blocks.

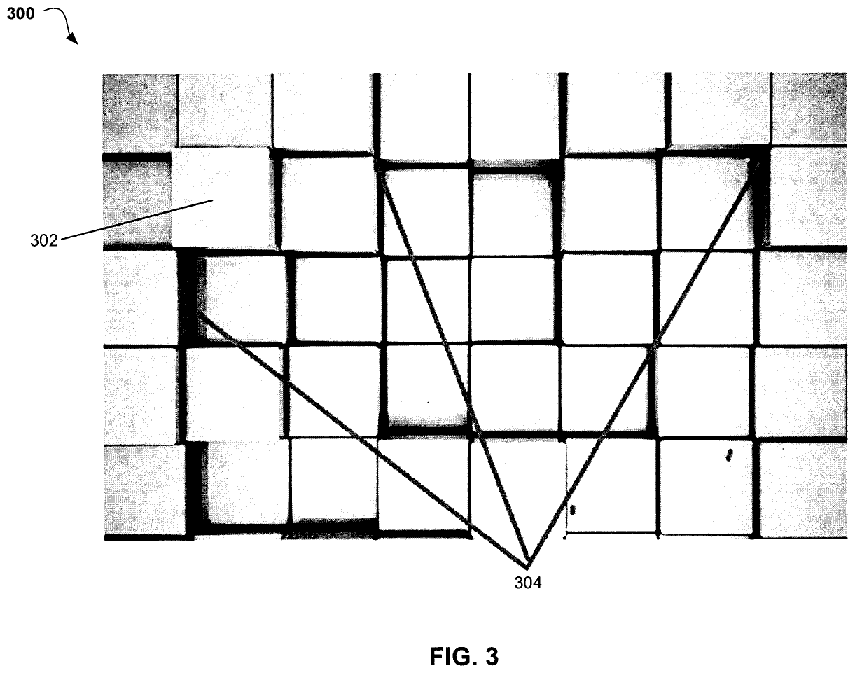

According to at least one embodiment, the gap may be defined by an opening that should have been filled during the assembly of the plurality of 3D blocks. For example, the gap may form between two successive 3D blocks, as illustrated in FIG. 3. According to at least one other embodiment, the improper alignment may be defined by a deviation from a required distance between surfaces of two successive 3D blocks. For example, where the required distance between the front surfaces of two successive 3D blocks is 1 foot, the two successive 3D blocks may be improperly aligned when the actual distance between the front surfaces is either greater than or less than the required distance of 1 foot. According to at least one further embodiment, the improper surface dimension of the at least one 3D block may be defined by a deviation from a required surface dimension of the at least one 3D block. For example, where the required surface dimension of a height of the at least one 3D block is 2 feet, and where the height is not uniform across the surface due to a chip in the at least one 3D block, the at least one 3D block may have the improper surface dimension.

In response to determining the at least one problem condition arises during the execution of the virtual simulation (step 206, “Yes” branch), the 3D printing solution process 200 proceeds to step 208 identify the at least one problem condition among the plurality of 3D blocks based on the execution of the virtual simulation. In response to determining the at least one problem condition does not arise during the execution of the virtual simulation (step 206, “No” branch), the 3D printing solution process 200 ends.

Then, at 208, the 3D printing solution program 150 identifies the at least one problem condition among the plurality of 3D blocks. The at least one problem condition is identified based on the execution of the virtual simulation. According to the at least one embodiment where there is the opening that should have been filled during the assembly of the plurality of 3D blocks, the at least one problem condition may be identified as the gap among the plurality of 3D blocks. According to the at least one other embodiment where there is the deviation from the required distance between the surfaces of two successive 3D blocks, the at least one problem condition may be identified as the improper alignment among the plurality of 3D blocks. According to the at least one further embodiment where there is the deviation from the required surface dimension of the at least one 3D block, the at least one problem condition may be identified as the improper surface dimension of the at least one 3D block in the plurality of 3D blocks.

According to at least one embodiment, identifying the at least one problem condition among the plurality of 3D blocks may also include identifying the location of the at least one problem condition. For example, the gap may be located between two successive 3D blocks that are separated from a base 3D block by 2 blocks. In another example, the improper surface dimension may be located 6 inches from a top edge of a 3D block directly atop the base 3D block.

Next, at 210, the 3D printing solution program 150 executes the digital twin simulation of the digital twin model of the plurality of physically assembled 3D blocks. The digital twin simulation is executed in accordance with the one or more factors. The 3D printing solution program 150 may use known techniques to create the digital twin model of each physically assembled 3D block, and this digital twin model may be used in the digital twin simulation. The digital twin of each physically assembled 3D block used in the simulation may have the same specifications each physically assembled 3D block has in the real-world. Additionally, the digital twin of each physically assembled 3D block used in the simulation may also have the same materials each physically assembled 3D block is made of in the real-world. For example, the plurality of physically assembled 3D blocks may be made of concrete. In this manner, maximum accuracy may be preserved during the digital twin simulation. The digital twin simulation may simulate the assembly of the plurality of physically assembled 3D blocks after these 3D blocks have been assembled in the real-world environment.

Examples of the factor include, but are not limited to, the weight and force the plurality of physically assembled 3D blocks exert on each other during the assembly, the coefficient of friction among the plurality of physically assembled 3D blocks during the assembly, the force of gravity exerted on the plurality of physically assembled 3D blocks during the assembly, the normal and shear forces that act between contacting surfaces of the plurality of physically assembled 3D blocks during the assembly, the Young's modulus of the ability of a material to withstand changes in length when subjected to tension or compression during the assembly, the type of 3D printer, the layer thickness of materials printed, and/or the printing material.

According to at least one embodiment, the digital twin simulation may be executed prior to the completion of the created object. In this embodiment, the digital twin simulation may be iterated in accordance with various stages of development until the object is completed. For example, when the object to be created is a building, the first digital twin simulation may be a simulation of the assembly of just the foundation. Continuing the example, when the sidewalls of the building are constructed, the second digital twin simulation may be a simulation of the assembly of the foundation and the sidewalls. According to at least one other embodiment, the digital twin simulation may be executed after the completion of the created object. For example, when the object to be created is the building, the digital twin simulation may be a simulation of the assembly of the entire building. In either embodiment, the results of executing the digital twin simulation may bolster the identification of the at least one problem condition and/or identify at least one additional problem condition.

Then, at 212, the 3D printing solution program 150 generates the correction plan including the one or more corrective actions to be performed on the plurality of physically assembled 3D blocks. The correction plan is generated based on the at least one problem condition and the executed digital twin simulation.

According to at least one embodiment, the generated correction plan may include an instruction to execute the corrective actions on the plurality of physically assembled 3D blocks before the created object is complete (i.e., during the assembly process) in response to identifying at least one first condition. Examples of the at least one first condition may include, but are not limited to, a number of gaps above a threshold, a size of the gaps above a threshold, the location of the gaps being accessible to ground-based 3D printers, and/or a level of complexity of the corrective action below a threshold. For example, where the threshold number of gaps is 5 gaps, when the number of gaps exceeds 5 the one or more corrective actions may be executed before the created object is complete. In another example, where the threshold size of the gaps is 0.5 inches, when the size of the gaps exceeds 0.5 inches the one or more corrective actions may be executed before the created object is complete. In another example, where corrective actions are ranked on a scale of 1-10 with 10 being the most difficult corrective action and where the threshold complexity level is 5, when the complexity level is below 5 the one or more corrective actions may be executed before the created object is complete.

According to at least one other embodiment, the generated correction plan may include an instruction to execute the corrective actions on the plurality of physically assembled 3D blocks after the created object is complete (i.e., after the assembly process) in response to identifying at least one second condition. Examples of the at least one second condition may include, but are not limited to, a number of gaps below the threshold, a size of the gaps below the threshold, the location of the gaps being inaccessible to ground-based 3D printers, and/or the level of complexity of the corrective action above the threshold. For example, where the threshold number of gaps is 5 gaps, when the number of gaps is less than 5 the one or more corrective actions may be executed after the created object is complete. In another example, where the threshold size of the gaps is 0.5 inches, when the size of the gaps is less than 0.5 inches the one or more corrective actions may be executed after the created object is complete. In another example, where corrective actions are ranked on a scale of 1-10 with 10 being the most difficult corrective action and where the threshold complexity level is 5, when the complexity level is above 5 the one or more corrective actions may be executed after the created object is complete.

According to at least one further embodiment, generating the correction plan may also include predicting the one or more corrective actions based on a future required maintenance action and one or more future environmental changes. The future required maintenance action may be a disassembling of the plurality of physically assembled 3D blocks. For example, materials subjected to stress over time may need to be replaced or refilled. In this example, depending on the strength required of the created object, one or more gaps may be left as is to reduce the time spent in the disassembly. The one or more future environmental changes may be a change in temperature, precipitation, and/or humidity over time. For example, where the created object is to be used outdoors in an area with high temperatures, the materials may melt or otherwise break down (e.g., a cracking of the material). In this example, the corrective action may be to 3D print a material capable of withstanding high temperatures. Thus, the types of materials to be printed by the 3D printer may be predicted based on any maintenance needs and/or changing environmental conditions. Furthermore, depending on the use of the created object, plastic waste may be recycled and used in the 3D printing filament.

Next, at 214, the 3D printing solution program 150 executes the one or more corrective actions on the plurality of physically assembled 3D blocks. The one or more corrective actions are executed based on the generated correction plan. Examples of the corrective action may include, but are not limited to, laying a material, pouring a liquid material, and/or spraying a material onto the created object at the location of the at least one problem condition. The execution of the one or more corrective actions may include 3D printing one or more materials as specified by the generated correction plan. For example, the generated correction plan may include an instruction to print a plastic material and/or a metallic material, and the instruction may be executed by the 3D printing solution program 150. Additionally, the generated correction plan may also include the mode of emitting (i.e., laying, pouring, and/or spraying) the one or more materials onto the plurality of physically assembled 3D blocks based on the location of the at least one problem condition, and the mode may be selected based on the location. Continuing the example, the generated correction plan may include an instruction to spray the plastic and/or the metallic material in the gap located between two successive 3D blocks that are separated from a base 3D block by 2 blocks, and the instruction may be executed by the 3D printing solution program 150.

According to at least one embodiment, where the generated correction plan may include the instruction to execute the corrective actions on the plurality of physically assembled 3D blocks before the created object is complete, the one or more corrective actions may be executed before the created object is complete. For example, the gap between two successive physically assembled 3D blocks may be filled before the created object is complete.

According to at least one other embodiment, where the generated correction plan may include the instruction to execute the corrective actions on the plurality of physically assembled 3D blocks after the created object is complete, the one or more corrective actions may be executed after the created object is complete. For example, the gap between two successive physically assembled 3D blocks may be filled after the created object is complete.

According to at least one further embodiment, the one or more materials may be emitted onto the plurality of physically assembled 3D blocks by a drone-based 3D printer in response to determining the location of the at least one problem condition is inaccessible to a ground-based 3D printer. For example, where the at least one problem condition is located 20 feet above the surface, the one or more materials may be emitted by the drone-based 3D printer. Thus, the 3D printers in peripheral device set 114 may be able to execute the one or more corrective actions utilizing swarm printing techniques.

Referring now to FIG. 3, an exemplary diagram 300 depicting a virtual assembly of a plurality of 3D blocks 302 requiring problem correction is shown according to at least one embodiment. In the diagram 300, the plurality of blocks 302 may be assembled to form the created object described above with respect to the description of FIG. 2. During the virtual simulation, a plurality of gaps 304 may form between two successive 3D blocks. According to at least one embodiment, depending on the strength required of the created object and future maintenance needs, one or more of the plurality of gaps 304 may be left as is to reduce the time spent in the disassembly of the created object. According to at least one other embodiment, one or more of the plurality of gaps 304 may be filled in accordance with the generated correction plan either before or after the created object is complete by the swarm 3D printers.

It may be appreciated that FIGS. 2 and 3 provide only an illustration of one implementation and do not imply any limitations with regard to how different embodiments may be implemented. Many modifications to the depicted environments may be made based on design and implementation requirements.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-based method of correcting a problem during an assembly of a 3D object utilizing a 3D printing solution, the method comprising:
receiving a 3D printing blueprint containing a description of a plurality of 3D blocks capable of being assembled to create an object;
executing a virtual simulation of the assembly of the plurality of 3D blocks based on the 3D printing blueprint;
determining whether at least one problem condition arises during the execution of the virtual simulation;
in response to determining the at least one problem condition arises, identifying the at least one problem condition among the plurality of 3D blocks based on the execution of the virtual simulation;
executing a digital twin simulation of a digital twin model of a plurality of physically assembled 3D blocks in accordance with one or more factors;
generating a correction plan including one or more corrective actions to be performed on the plurality of physically assembled 3D blocks based on the at least one problem condition and the executed digital twin simulation; and
executing the one or more corrective actions on the plurality of physically assembled 3D blocks based on the generated correction plan.

2. The computer-based method of claim 1, wherein generating the correction plan further comprises:
predicting the one or more corrective actions based on a future required maintenance action and one or more future environmental changes.

3. The computer-based method of claim 1, wherein the generated correction plan includes an instruction to execute the one or more corrective actions on the plurality of physically assembled 3D blocks before the created object is complete in response to identifying at least one first condition.

4. The computer-based method of claim 1, wherein the generated correction plan includes an instruction to execute the one or more corrective actions on the plurality of physically assembled 3D blocks after the created object is complete in response to identifying at least one second condition.

5. The computer-based method of claim 1, wherein executing the one or more corrective actions further comprises:
3D printing one or more materials, wherein a mode of emitting the one or more materials onto the plurality of physically assembled 3D blocks is selected based on a location of the identified at least one problem condition.

6. The computer-based method of claim 5, wherein the one or more materials are emitted onto the plurality of physically assembled 3D blocks by a drone-based 3D printer in response to determining the location of the identified at least one problem condition is inaccessible to a ground-based 3D printer.

7. The computer-based method of claim 1, wherein the problem condition is selected from a group consisting of a gap among the plurality of 3D blocks, an improper alignment among the plurality of 3D blocks, and an improper surface dimension of at least one 3D block in the plurality of 3D blocks.

8. A computer system, the computer system comprising:
one or more processors, one or more computer-readable memories, one or more computer-readable tangible storage medium, and program instructions stored on at least one of the one or more computer-readable tangible storage medium for execution by at least one of the one or more processors via at least one of the one or more computer-readable memories, wherein the computer system is capable of performing a method comprising:
receiving a 3D printing blueprint containing a description of a plurality of 3D blocks capable of being assembled to create an object;
executing a virtual simulation of the assembly of the plurality of 3D blocks based on the 3D printing blueprint;
determining whether at least one problem condition arises during the execution of the virtual simulation;
in response to determining the at least one problem condition arises, identifying the at least one problem condition among the plurality of 3D blocks based on the execution of the virtual simulation;
executing a digital twin simulation of a digital twin model of a plurality of physically assembled 3D blocks in accordance with one or more factors;
generating a correction plan including one or more corrective actions to be performed on the plurality of physically assembled 3D blocks based on the at least one problem condition and the executed digital twin simulation; and
executing the one or more corrective actions on the plurality of physically assembled 3D blocks based on the generated correction plan.

9. The computer system of claim 8, wherein generating the correction plan further comprises:
predicting the one or more corrective actions based on a future required maintenance action and one or more future environmental changes.

10. The computer system of claim 8, wherein the generated correction plan includes an instruction to execute the one or more corrective actions on the plurality of physically assembled 3D blocks before the created object is complete in response to identifying at least one first condition.

11. The computer system of claim 8, wherein the generated correction plan includes an instruction to execute the one or more corrective actions on the plurality of physically assembled 3D blocks after the created object is complete in response to identifying at least one second condition.

12. The computer system of claim 8, wherein executing the one or more corrective actions further comprises:
3D printing one or more materials, wherein a mode of emitting the one or more materials onto the plurality of physically assembled 3D blocks is selected based on a location of the identified at least one problem condition.

13. The computer system of claim 12, wherein the one or more materials are emitted onto the plurality of physically assembled 3D blocks by a drone-based 3D printer in response to determining the location of the identified at least one problem condition is inaccessible to a ground-based 3D printer.

14. The computer system of claim 8, wherein the problem condition is selected from a group consisting of a gap among the plurality of 3D blocks, an improper alignment among the plurality of 3D blocks, and an improper surface dimension of at least one 3D block in the plurality of 3D blocks.

15. A computer program product, the computer program product comprising:
one or more computer-readable tangible storage medium and program instructions stored on at least one of the one or more computer-readable tangible storage medium, the program instructions executable by a processor capable of performing a method, the method comprising:
receiving a 3D printing blueprint containing a description of a plurality of 3D blocks capable of being assembled to create an object;
executing a virtual simulation of the assembly of the plurality of 3D blocks based on the 3D printing blueprint;
determining whether at least one problem condition arises during the execution of the virtual simulation;
in response to determining the at least one problem condition arises, identifying the at least one problem condition among the plurality of 3D blocks based on the execution of the virtual simulation;
executing a digital twin simulation of a digital twin model of a plurality of physically assembled 3D blocks in accordance with one or more factors;
generating a correction plan including one or more corrective actions to be performed on the plurality of physically assembled 3D blocks based on the at least one problem condition and the executed digital twin simulation; and
executing the one or more corrective actions on the plurality of physically assembled 3D blocks based on the generated correction plan.

16. The computer program product of claim 15, wherein generating the correction plan further comprises:
predicting the one or more corrective actions based on a future required maintenance action and one or more future environmental changes.

17. The computer program product of claim 15, wherein the generated correction plan includes an instruction to execute the one or more corrective actions on the plurality of physically assembled 3D blocks before the created object is complete in response to identifying at least one first condition.

18. The computer program product of claim 15, wherein the generated correction plan includes an instruction to execute the one or more corrective actions on the plurality of physically assembled 3D blocks after the created object is complete in response to identifying at least one second condition.

19. The computer program product of claim 15, wherein executing the one or more corrective actions further comprises:
3D printing one or more materials, wherein a mode of emitting the one or more materials onto the plurality of physically assembled 3D blocks is selected based on a location of the identified at least one problem condition.

20. The computer program product of claim 19, wherein the one or more materials are emitted onto the plurality of physically assembled 3D blocks by a drone-based 3D printer in response to determining the location of the identified at least one problem condition is inaccessible to a ground-based 3D printer.
